(19) United States
(12) Patent Application Publication
(10) Pub. No.: US 2015/0301930 A1
(43) Pub. Date: Oct. 22, 2015

(54) FILE STORAGE VIA PHYSICAL BLOCK ADDRESSES

(71) Applicant: HGST Netherlands B.V., Amsterdam (NL)

(72) Inventors: Curtis H. Bruner, Niwot, CO (US); Christopher Squires, Boulder, CO (US)

(73) Assignee: HGST Netherlands B.V., Amsterdam (NL)

(21) Appl. No.: 14/256,755

(22) Filed: Apr. 18, 2014

(51) Int. Cl. G06F 12/02; G06F 12/10

(52) U.S. Cl. CPC G06F 12/023; G06F 12/1036; G06F 2212/7211; G06F 2212/1044

(57) ABSTRACT

Examples disclosed herein provide systems, methods, and software for storing objects, such as files, via physical block addresses and media characteristics. In one example, a method for operating a processing system on a storage device includes identifying media characteristics for a storage media. The method further includes, for a given object received over a network and in association with a network storage request, identifying a plurality of physical block addresses for the given object based on the media characteristics. The method also includes initiating a transfer of the object from memory to the storage media.

### TECHNICAL BACKGROUND

Serving devices are used to provide file storage to one or more client devices using Ethernet or some other similar protocol. Typically, when an object or file is to be stored to one of the serving devices from one of the client devices, the data is passed, using a data bus, from the client processing unit to a network interface controller (NIC) on the client device. From the client NIC, the data is passed using Ethernet or some other similar protocol to the serving device where it can be processed and stored to the desired storage media.

In a previous method of operating a serving device, the processing unit on the serving device will receive the file via a serving NIC and convert the file into data blocks with logical block addresses (LBAs). These data blocks with LBAs are then passed to a storage controller that is configured to associate the LBAs with physical block addresses or PBAs. Once associated, the storage controller uses the PBAs to place the data blocks into the storage media.

### OVERVIEW

Examples disclosed herein provide systems, methods, and software for storing objects via physical block addresses and media characteristics. In one example, a method for operating a processing system on a storage device includes identifying media characteristics for a storage media. The method further includes, for a given object received over a network and in association with a network storage request, identifying a plurality of physical block addresses for the given object based on the media characteristics. The method also includes initiating a transfer of the given object to the storage media.

In another example, a computer apparatus to facilitate storage to physical block addresses based on media characteristics includes processing instructions that direct a storage processing computing system to identify the media characteristics for a storage media. The instructions further direct the computing system to identify a plurality of physical block addresses for a given object based on the media characteristics, and initiate a transfer of the given object to the plurality of physical block addresses on the storage media. The apparatus also includes one or more non-transitory computer readable media that store the processing instructions.

In a further instance, a storage device comprises at least a storage controller configured to identify the media characteristics for a storage media and transfer the media characteristics for delivery to a processing system. The processing system is configured to receive the media characteristics for the storage media, identify a plurality of physical block addresses for a given object based on the media characteristics, and initiate a transfer of the given object to the plurality of physical block addresses on the storage media.

### BRIEF DESCRIPTION OF THE DRAWINGS

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates a storage system for storing an object to a plurality of physical block addresses.

FIG. 2 illustrates a method for storing an object based on media characteristics.

FIG. 3 illustrates a storage system with multiple storage devices.

FIG. 4 illustrates a storage device according to one example.

FIG. 5 illustrates a timing diagram for storing an object based on media characteristics.

FIG. 6 illustrates a storage device according to another example.

FIG. 7 illustrates an overview for storing an object in a storage device based on media characteristics.

FIG. 8 illustrate a storage processing computing system configured to store an object based on media characteristics.

### DETAILED DESCRIPTION

Storage computing systems, such as servers and network attached storage devices, allow other computing devices to offload portions of their storage processing workload. By offloading the storage management, the other computing devices may have more resources to execute processing intensive tasks, and may also require less storage on the local device.

In the present example, a storage system is included that allows other networked devices to store objects, such as files, quickly and efficiently. To accomplish this task, a processing system on a storage device will identify media characteristics for a storage media. These media characteristics may include a variety of factors including shingling information for the media, health or wear level information for the media, space availability for the media, amongst a variety of other factors. In some examples, the media characteristics may be passed to the processing system by a storage controller that is connected to the storage media and is configured to monitor the status of the media.

Once the characteristics are identified by the processing system, an object may be passed with a storage request to the storage device. This object or file may come from any number of networked computing devices configured to communicate with the storage device. Upon arrival at the storage device, the object will be passed to the processing system to identify a plurality of physical block addresses for the given object based on the media characteristics. These physical block addresses may then be used in storing the object to the storage media. In some examples, various object characteristics may also be used by the processing system to determine the physical block addresses for the object. Such object characteristics may include the size of the object, the type of object, or any other relevant attributes for the object.

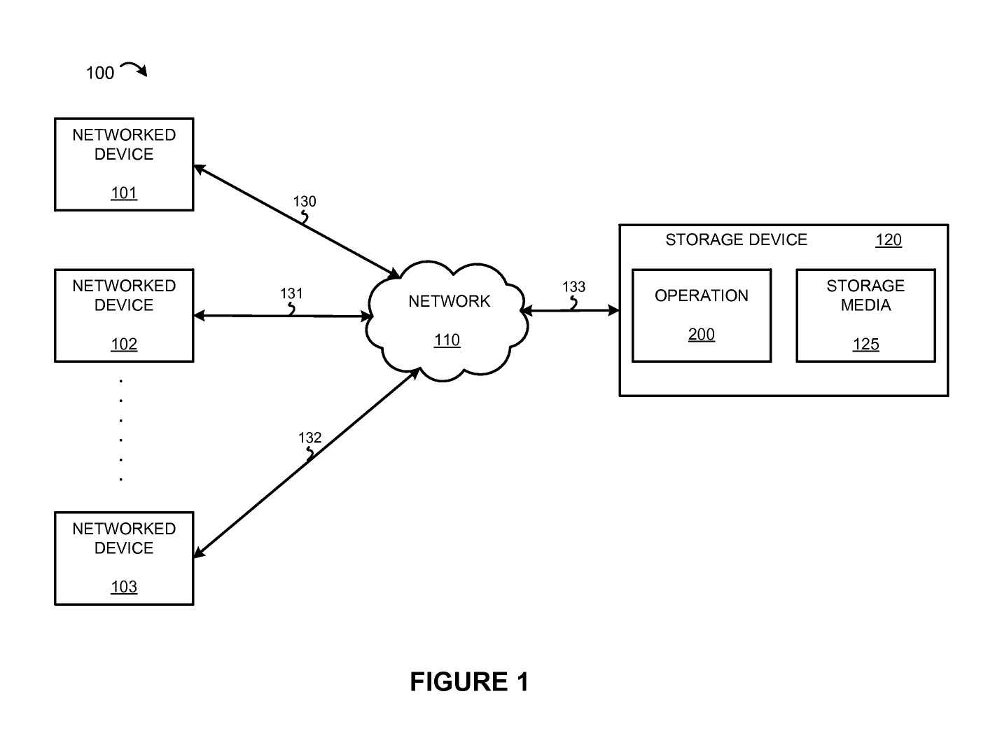

To further illustrate the operation of the storage device, FIG. 1 is included. FIG. 1 illustrates a storage system 100 for storing objects to a plurality of physical block addresses (PBAs) on a storage device. Storage system 100 includes networked devices 101-103, network 110, and storage device 120. Storage device 120 further includes storage media 125 and is configured to execute operation 200. Networked devices 101-103 communicate with network 110 over communication links 130-132, and network 110 is further configured to communicate with storage device 120 over communication link 133.

Networked devices 101-103 may include any computing system capable of transferring an object for storage in storage device 120. Networked devices 101-103 may each include processing systems, communication interfaces, storage systems, user interfaces, or some other computing element. Each of networked devices 101-103 may be a computer, smartphone, e-book, mobile Internet appliance, media player, game console, or some other computing apparatus—including combinations thereof.

Network 110 is configured to provide communication services to networked devices 101-103 and to allow the devices to connect to storage device 120. Network 110 may comprise switches, access nodes, Internet routers, network gateways, application servers, computer systems, communication links, or some other type of communication equipment—including combinations thereof.

Storage device 120 is configured to store objects that are communicated from the plurality of networked devices. In addition to storage media 125, storage device 120 may include a processing system, a storage controller, a network interface controller (NIC), memory, or other storage related systems. Storage device 120 is configured to take an object from networked devices 101-103 and store the object using PBAs to storage media 125.

Communication links 130-133 use metal, glass, air, space, or some other material as the transport media. Communication links 130-133 could use various communication protocols, such as Time Division Multiplex (TDM), Internet Protocol (IP), Ethernet, communication signaling, Code Division Multiple Access (CDMA), Evolution Data Only (EVDO), Worldwide Interoperability for Microwave Access (WIMAX), Global System for Mobile Communication (GSM), Long Term Evolution (LTE), Wireless Fidelity (WIFI), High Speed Packet Access (HSPA), or some other communication format—including combinations thereof. Communication links 130-133 could be direct links or may include intermediate networks, systems, or devices.

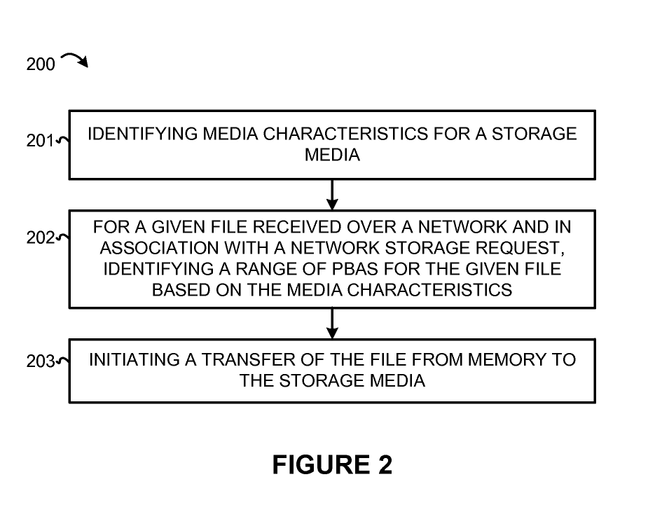

Turning now to FIG. 2, FIG. 2 illustrates operation 200 for storing objects into a storage media using PBAs. In operation, storage device 120 includes at least a NIC, a processing system, a storage controller, and storage media 125 to store the objects that are transferred from networked devices 101-103. To facilitate the storage of the objects, the processing system is configured to execute operation 200. Operation 200 includes identifying media characteristics for storage media 125 (201). In some examples, the storage controller on storage device 120 determines the media characteristics, and transfers these characteristics back to the processing system. Such media characteristics may include shingling information for the media, health information for the media, space availability for the media, amongst a variety of other characteristics. Once identified, the characteristics can be used by the processing system to identify storage locations.

In the present operation, for a given object received over a network and in association with a network storage request, the processing system is configured to identify a plurality of PBAs for the given object based on the media characteristics (202). In some instances, the plurality of PBAs allows an object to be stored sequentially within the storage media avoiding the object being dispersed amongst a variety of locations. However, it should be understood that the plurality of PBAs might include any addresses on the storage media. Once the PBAs are determined, storage device 120 is configured to initiate a transfer of the object from memory to the storage media (203).

For an illustrative example, networked device 101 may require that an object be stored on storage device 120. Prior to the object being delivered to storage device 120 with a storage request, the storage controller is configured to gather media characteristics about storage media 125 and pass these characteristics to the processing system. Once the characteristics are gathered, storage device 120 is then prepared to receive objects from the various networked devices. Using the present example, networked device 101 can transfer the object for storage on storage device 120. A NIC on device 120 is configured to receive the object and transfer the object to the processing system to identify the plurality of PBAs to store the object. These PBAs are then used to store the object via data blocks within the storage media.

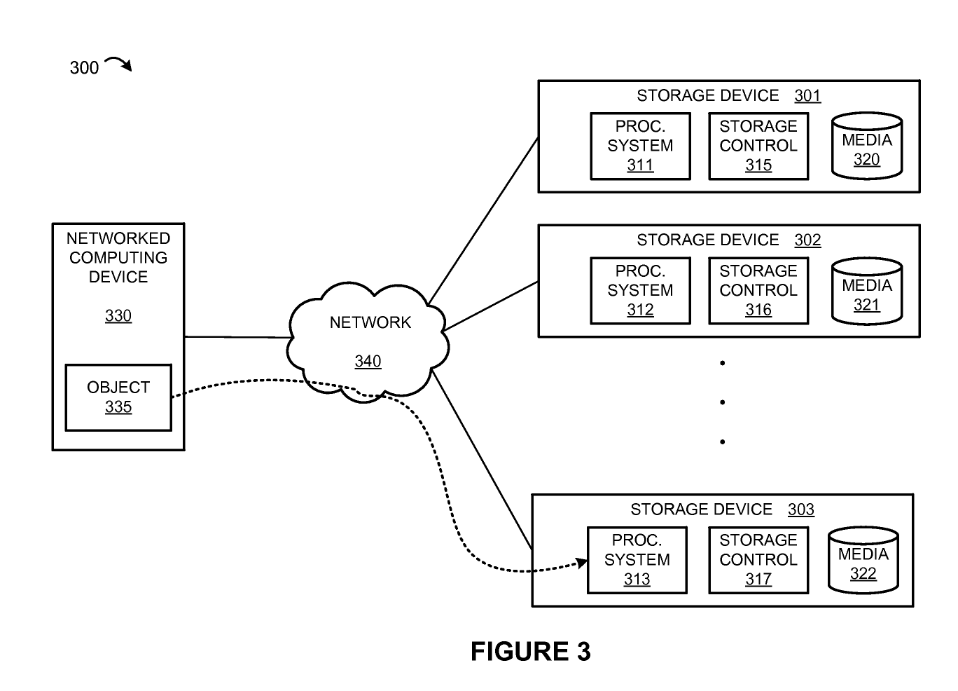

Turning to FIG. 3, FIG. 3 is included to illustrate a system 300 for storing an object to a storage device using PBAs. FIG. 3 includes storage devices 301-303, network 340, and networked computing device 330. Storage devices 301-303 include processing systems 311-313, storage controllers 315-317, and storage media 320-322. Networked computing device 330 further includes object 335, which may be stored or operated on by device 330.

In operation, storage controllers 315-317 are configured to gather media characteristics about storage media 320-322. These media characteristics may include information about shingling on drives in the storage media, the health of the storage media, the availability or space on the storage media, amongst other possible media characteristic factors. Shingling, or shingled magnetic recording, allows relatively wide tracks to be written to the storage media and successively written tracks to partially overlap the previous tracks. By monitoring the shingling within storage media 320-322, storage controllers 315-317 may ensure that new writes to the media do not overlap or destroy previous objects that were stored to the drive.

Once the media characteristics have been determined, storage controllers 315-317 are configured to pass the characteristics to processing systems 311-313 to enable PBA determinations for incoming objects. Using FIG. 3 as an example, object 335 from networked computing device 330 is directed to be stored on storage device 303. To accomplish this task, object 335, along with a storage request, are delivered over network 340 to storage device 303. Storage device 303 is configured to receive the object, using a NIC or other similar network interface, and provide the object to processing system 313. Processing system 313 is designed to identify a plurality of PBAs for object 335 based on the media characteristics gathered by storage controller 317. Upon identification of the PBAs, processing system 313 may initiate storage of object 335 to storage media 322.

In some examples, storage device 303 may include shared memory between processing system 313 and storage controller 317. This shared memory allows the processing system to place an object into memory and the storage controller to directly draw the object from memory. In other instances, storage device 303 may include multiple memory systems for processing system 313 and storage controller 317. Thus, processing system 313 and storage controller 317 may not be able to share the object or PBAs using a shared memory.

Further, processing systems 311-313 may each include a file system that is configured to organize and manage the object storage. These file systems are responsible controlling the storage and retrieval of the objects from the storage media. Accordingly, the file systems within the processing systems may be responsible for identifying the plurality of PBAs based on the media characteristics.

Although illustrated with three storage devices in the present example, it should be understood that system 300 might include any number of storage devices to store objects. In some instances, the storage devices may comprise a storage array, where each individual device is configured as a network attached storage element.

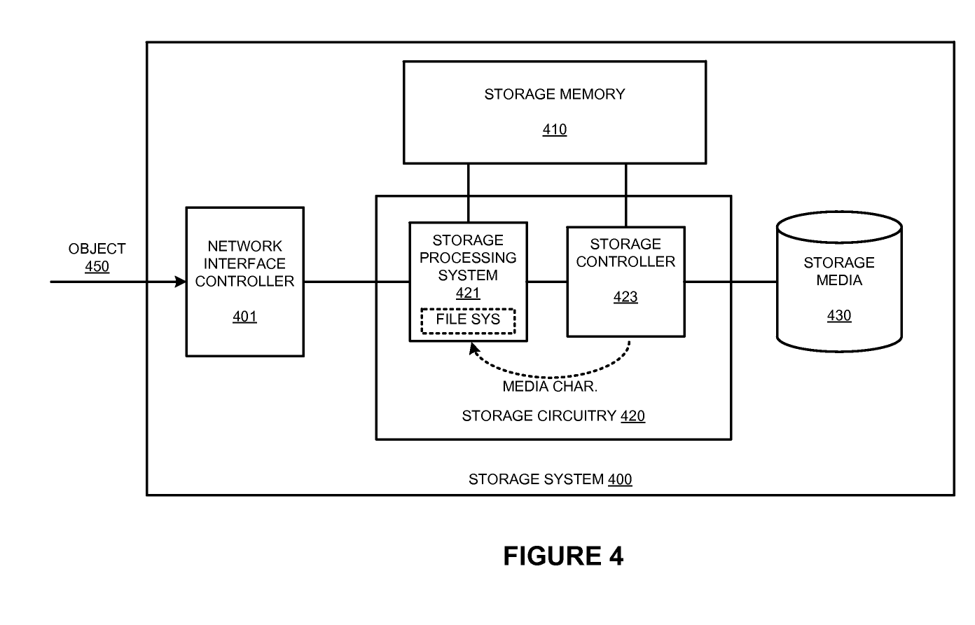

FIG. 4 illustrates a storage system 400 for storing objects using PBAs and media characteristics. Storage system 400 is an example of storage device 120, although other examples may exist. Storage system 400 includes network interface controller (NIC) 401, storage memory 410, storage circuitry 420, and storage media 430. Storage circuitry 420 further includes storage processing system 421 and storage controller 423.

In operation, storage controller 423 is configured to identify media characteristics for storage media 430. Storage media 430 may comprise a non-transitory computer readable storage medium, such as a disk drive, flash drive, data storage circuitry, or some other hardware memory apparatus. Storage media 430 may comprise a single device, or may be distributed across multiple devices. In some examples, the media characteristics gathered by storage controller 423 comprise a variety of storage factors, including shingling characteristics of the media, space available within the media, and the health of the media, amongst a variety of other factors. These characteristics can be passed to an object system within storage processing system 421 to identify physical block address locations for objects that are to be stored in storage system 400.

In some instances, storage processing system 421 and the associated file system may be configured to track media characteristics that can supplement the information provided by storage controller 423. These supplemented media characteristics may include information about the addresses previously used to store objects, information about the space remaining in storage media 430, or any other useful information in determining PBAs for incoming objects. Once identified, the supplemental characteristics can be implemented with the media characteristics from storage controller 423 to determine the PBAs for incoming objects.

In an illustrative example, an object such as incoming object 450 is delivered to storage system 450 to be stored on storage media 430. Storage system 400 is configured to receive the object and the storage request at network interface controller 401. Network interface controller 401 connects storage system 400 to a computer network allowing the system to communicate with one or more other computing devices that require storage on the computing system. Once received at network interface controller 401, object 450 is then passed to storage processing system 421. Upon receipt of object 450 and the storage request, processing system 421 is configured to identify a plurality of PBAs for the given object based on the media characteristics. Once the locations are identified, storage processing system 421 can then initiate the storage of the object within storage media 430.

In some examples, when the object is passed to processing system 421, the object is placed in storage memory 410 until it can be placed in storage media 430. Storage memory 410 is configured as shared memory in the present example, which allows access for both storage processing system 421 and storage controller 423. As a result, once the PBAs are identified for the object that was placed in storage memory 410, the object can be brought out of storage memory 410 by storage controller 423 and placed in storage media 430.

Once the object is stored in the storage media, storage controller 423 and storage processing system 421 can further update or identify media characteristics based on the newly stored object. This may include adjusting the available space within the storage media, identifying any new shingling effects to the storage media, or identifying a change in health on the storage media.

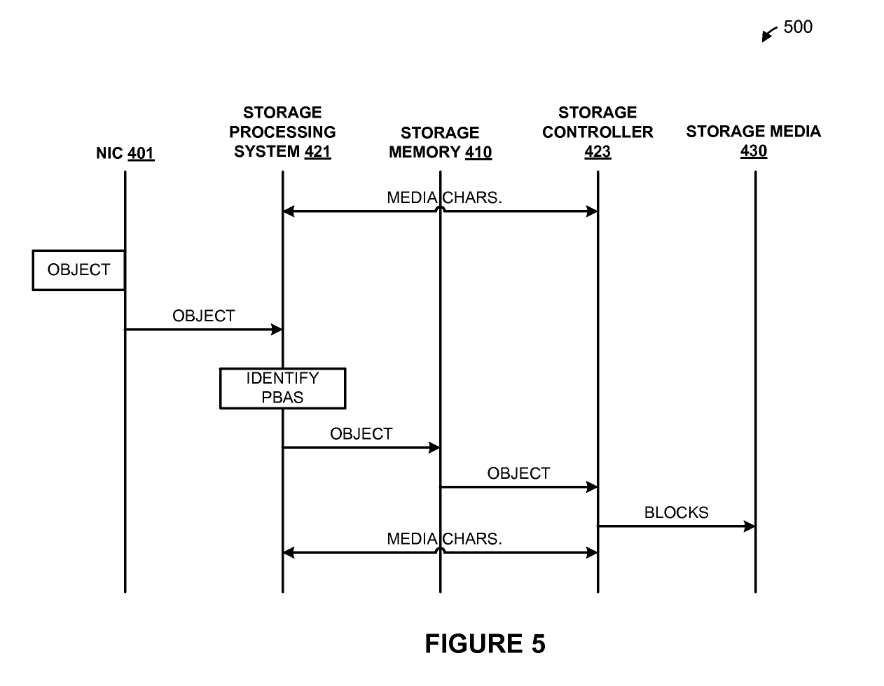

To further illustrate the operation of storage system 400, timing diagram 500 is included in FIG. 5. As shown, storage controller 423 is configured to pass media characteristics to storage processing system 421. Such media characteristics can include information about available storage, shingling, and the health of the storage media. While these characteristics are being monitored, an object may arrive at NIC 401 indicating a request to store the object to the storage media. Once arrived, the object may be passed to storage processing system 421 to identify PBAs for the object based on the media characteristics, and placed in storage memory 410.

Upon identification of the physical block addresses for the object, storage processing system 421 is configured to initiate storage of the object into the storage media. Using the present example, the object blocks are brought out of memory by storage controller 423 and transferred to the appropriate PBAs identified by processing system 421.

In the present instance, storage processing system 421 and storage controller 423 share storage memory 410. As a result both elements of storage circuitry 420 have access to the memory. Further, once an object is placed in storage memory 410 by processing system 421, storage controller 423 can pull the object out of memory and transfer blocks of the object to the appropriate PBAs on storage media 430. Once the transfer is complete, storage processing system 421 and storage controller 423 may update the media characteristics to reflect the newly stored object.

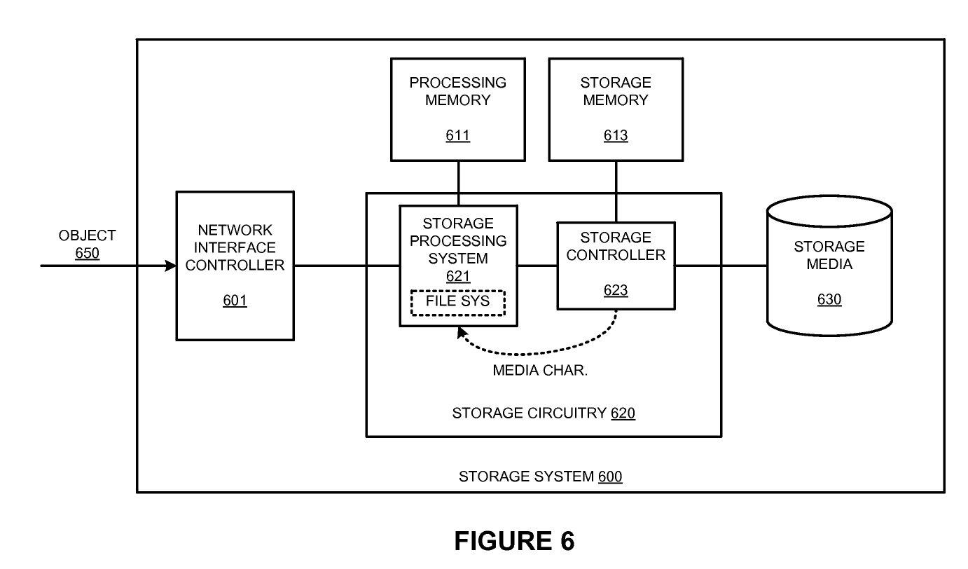

Turning now to FIG. 6, FIG. 6 illustrates a storage system 600 according to another example. Storage system 600 is an example of storage device 120, although other examples may exist. Storage system 600 includes, network interface controller (NIC) 601, processing memory 611, storage memory 613, storage circuitry 620, and storage media 630. Storage circuitry 620 further includes storage processing system 621 and storage controller 623.

In operation, storage system 600 and the corresponding file system are configured to operate similar to system 400 described in FIG. 4. Storage processing system 621 is configured to identify media characteristics regarding storage media 630. These media characteristics can be passed from storage controller 623 to processing system 621 in some examples, but may also be generated by storage processing system 621. Based on these media characteristics, storage processing system is configured to receive object 650 from NIC 601 and identify a plurality of PBAs for the object. Once the PBAs are identified, the object may then be transferred to the storage controller, which will handle the procedures necessary to place the object into memory.

In contrast to the system described in FIG. 4, storage system 600 includes separate memory for the storage processing system and the storage controller. As a result, once the PBAs are determined by the storage processing system, the object may then need to be transferred to a separate memory module for the storage controller until the object blocks can be saved in the storage media.

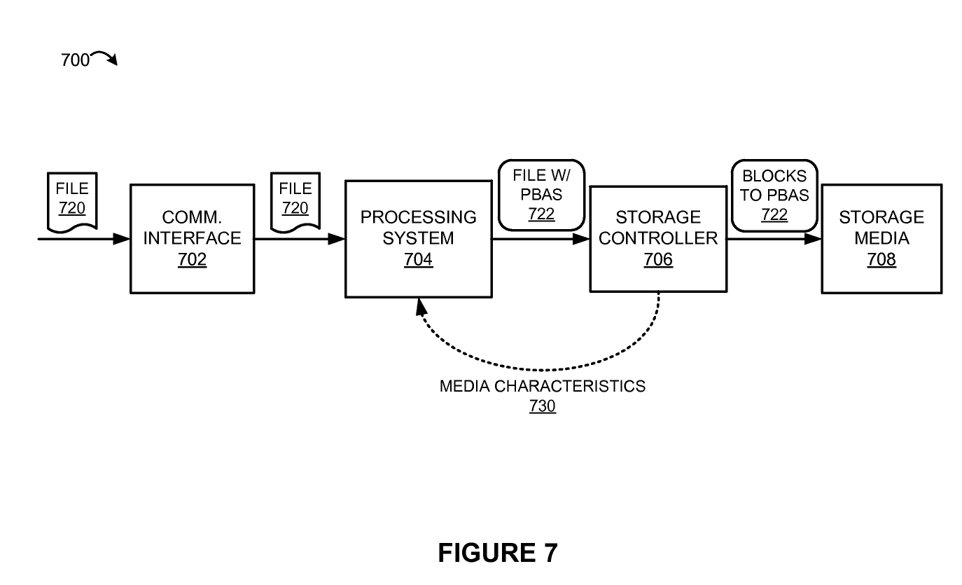

Referring now to FIG. 7, FIG. 7 illustrates an overview 700 for storing an object to PBAs based on media characteristics. Overview 700 includes communication interface 702, processing system 704, storage controller 706, and storage media 708. Communication interface may be a network interface controller or any other similar communication interface configured to receive objects over a network from other computing devices or systems.

In operation, processing system 704 is configured to identify media characteristics regarding storage media 708. These media characteristics may be gathered by storage controller 706, and may be supplemented with characteristics determined by processing system 704. Such media characteristics may include the amount of available space that remains on storage media 708, shingling information regarding storage media 708, health information about storage media 708, or any other useful information for determining physical block addresses to store objects.

Using FIG. 7 as an example, object 720 is delivered to communication interface 702 from a communication network. The communication network may allow one or more other computing devices to communicate with and store various objects to storage media 708. Once the object arrives at that communication interface, the object is then transferred to processing system 704 where the media characteristics will be used to determine a plurality of PBAs for the object on the storage media. In some instances, processing system 704 may be configured with a file system to organize the objects that are transferred from the other devices. This file system may rely, at least partially, on the media characteristics to determine the proper storage location for the objects in the media.

Once the PBAs are determined by processing system 704, the object in the form of data blocks is placed in storage media 708 by storage controller 706. In some examples, prior to the object being placed in the storage media, the object can be placed in temporary storage memory. This storage memory may allow both the processing system and the storage controller to access the object. Thus, the processing system may push the object into the storage memory, and the storage controller may take it out and transfer the object in the form of blocks to the appropriate PBAs.

Upon storage of the object in storage media 708, processing system 704 and storage controller 706 may update media characteristics 730 to reflect the storage changes. Further, in some instances, the media characteristics may be updated periodically to ensure that the information matches the current state and health of the storage media.

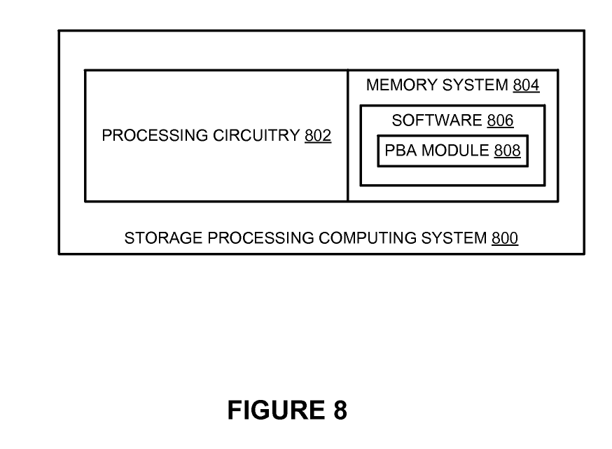

Referring now to FIG. 8, FIG. 8 illustrates a storage processing computing system 800 for identifying PBAs based on media characteristics. Storage processing computing system 800 is an example of storage processing system 421 and storage processing system 621, although other examples may exist. Storage processing computing includes processing circuitry 802 and memory system 804. Memory system 804 further includes software 806, which is configured to operate computing system 800 as described herein.

Processing circuitry 802 may comprise a microprocessor and other circuitry that retrieves and executes software 806 from memory system 804. Software 806 includes PBA module 808, which is configured to implement operation 200. Processing circuitry 802 may be implemented within a single processing device, but may also be distributed across multiple processing devices or sub-systems that cooperate in executing program instructions. Examples of processing circuitry 802 include general-purpose central processing units, application specific processors, and logic devices, as well as any other type of processing device.

Memory system 804 may comprise any storage media readable by processing circuitry 802 and capable of storing software 806. Memory system 804 may include volatile and nonvolatile, removable and non-removable media implemented in any method or technology for storage of information, such as computer readable instructions, data structures, program modules, or other data. Memory system 804 may be implemented as a single storage device, but may also be implemented across multiple storage devices or sub-systems. Memory system 804 may comprise additional elements, such as a controller to read software 806 in some examples.

Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Software 806 comprises computer program instructions to facilitate the identification of PBAs for incoming object storage requests. Software 306 may also comprise firmware, or some other form of machine-readable processing instructions having PBA identification process 200 embodied thereon. Software 806 may be implemented as a single application, but also as multiple applications.

In some examples, storage processing computing system may be communicatively coupled to a network interface controller, a storage memory module, and a storage controller. The network interface controller is used to receive objects to be stored over a network. The storage memory module is used to store the objects temporarily before they can be delivered to the appropriate locations on the storage media. And, the storage controller is used to communicate with storage media to store the objects and gather media characteristics.

In operation, software 806 directs storage processing computing system 800 to identify a plurality of PBAs for an object based on media characteristics. More specifically, software 806 and PBA module 808 direct processing circuitry 802 to identify media characteristics from a storage controller that is communicatively coupled to storage media. These media characteristics may include information about the space available within the storage media, the health of the storage media, and the shingling state for the storage media. The shingling state may include information about overlapping tracks to ensure that a new object is not overwriting a previously written track.

Although media characteristics are gathered from the storage controller, it should be understood that media characteristics might also be identified by storage processing computing system 800. These characteristics may include information about the PBAs previously used and the space available on the storage media, amongst other possible characteristics. Further, in some instances, computing system 800 may be configured to identify object characteristics, such as the size or type of object, which may be useful in identifying PBAs in the storage media.

Once the characteristics are identified, storage processing computing system 800 may prepare an object to be stored to the storage media. In some occurrences, computing system 800 is coupled to a network interface controller. This network interface controller is configured to receive an object over a network and pass the object to storage processing computing system 800. Upon delivery, computing system 800 will determine a plurality of PBAs for the object based on the media characteristics.

In some examples, during the determination of the plurality of PBAs, the object is stored in storage memory until it can be moved into the final storage media. Once the PBAs are identified, computing system 800 may then initiate the storage of the object into the final storage media. This may include, in some instances, transferring the object from memory to the storage controller that will place the object in the form of blocks to the appropriate location on the storage media.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A computer apparatus to facilitate storage to physical block addresses based on media characteristics, the computer apparatus comprising:
processing instructions that direct a storage processing computing system, when executed by the storage processing computing system, to:
identify the media characteristics for a storage media;
for a given object received over a network and in association with a network storage request, identifying a plurality of physical block addresses for the given object based on the media characteristics; and
initiate a transfer of the given object to the plurality of physical block addresses on the storage media; and
one or more non-transitory computer readable media that store the processing instructions.

2. The computer apparatus of claim 1 wherein the processing instructions that direct the storage processing computing system to identify the media characteristics for the storage media direct the storage processing computing system to receive the media characteristics from a storage controller communicatively coupled to the storage media.

3. The computer apparatus of claim 1 wherein the media characteristics comprise at least shingling information about the storage media.

4. The computer apparatus of claim 1 wherein the media characteristics comprise at least availability information for the storage media.

5. The computer apparatus of claim 1 wherein the given object received over the network is stored in memory prior to initiating the transfer of the given object to the plurality of physical block addresses on the storage media.

6. The computer apparatus of claim 5 wherein the processing instructions to initiate the transfer of the given object to the plurality of physical block addresses on the storage media direct the storage processing computing system to initiate a data transfer of the given object from the memory to the plurality of physical block addresses on the storage media.

7. The computer apparatus of claim 1 wherein the processing instructions further direct the storage processing computing system to, upon initiating the transfer of the given object, identify further media characteristics for the storage media.

8. The computer apparatus of claim 1 wherein the processing instructions to identify the plurality of physical block addresses for the given object based on the media characteristics direct the storage processing computing system to identify the plurality of physical block addresses for the given object based on the media characteristics and object characteristics.

9. The computer apparatus of claim 1 wherein the media characteristics comprise wear level information about the storage media.

10. The computer apparatus of claim 1 wherein the given object comprises a file.

11. A storage device for storing objects based on media characteristics comprising:
a storage controller configured to:
identify the media characteristics for a storage media; and
transfer the media characteristics to a processing system; and
the processing system configured to:
receive the media characteristics for the storage media;
for a given object received over a network and in association with a network storage request, identify a plurality of physical block addresses for the given object based on the media characteristics; and
initiate a transfer of the given object to the plurality of physical block addresses on the storage media.

12. The storage device of claim 11 wherein the processing system configured to identify the plurality of physical block addresses for the given object based on the media characteristics is configured to identify the plurality of physical block addresses for the given object based on the media characteristics and object characteristics.

13. The storage device of claim 11 wherein the given object is stored in a memory device prior to initiating the transfer of the given object to the plurality of physical block addresses on the storage media.

14. The storage device of claim 13 wherein the processing system configured to initiate the transfer of the given object to the plurality of physical block addresses on the storage media is configured to initiate a data transfer of the given object from the memory device to the plurality of physical block addresses on the storage media.

15. The storage device of claim 11 wherein the media characteristics comprise wear level information about the storage media.

16. The storage device of claim 11 wherein the media characteristics comprise at least availability information for the storage media.

17. The storage device of claim 11 wherein the given object comprises a file.
